(19) United States
(12) Patent Application Publication
(10) Pub. No.: US 2020/0223251 A1
(43) Pub. Date: Jul. 16, 2020

(54) Traction Enhancing Device

(71) Applicant: Alex Malishkevich, Edgewater, NJ (US)

(72) Inventor: Alex Malishkevich, Edgewater, NJ (US)

(21) Appl. No.: 16/249,281

(22) Filed: Jan. 16, 2019

(51) Int. Cl. B60B 15/18; B60C 27/20; B60C 27/02

(52) U.S. Cl. CPC B60B 15/18; B60C 27/0238; B60C 27/20

(57) ABSTRACT

A traction enhancing device for a vehicle includes a plurality of spikes that is coupled to and extends from an outer face of a panel that is bendable and configured to conform to a circumference of a tire. A plurality of first straps and a plurality of second straps are coupled to a first edge and a second edge of the panel, respectively. Each second strap and an associated first strap are configured to loopedly position around the tire and a rim of a vehicle. Each of a plurality of first couplers and each of a plurality of second couplers are coupled to a respective first strap and a respective second strap, respectively, distal from the panel. Each second coupler is positioned to couple to an associated first coupler to couple the panel to the tire, positioning the spikes to insert into a substrate to increase traction of the tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relate to traction enhancing devices and more particularly pertains to a new traction enhancing device for a vehicle.

### BRIEF SUMMARY OF THE INVENTION

An embodiment of the disclosure meets the needs presented above by generally comprising a plurality of spikes that is coupled to and extends from an outer face of a panel that is bendable and configured to conform to a circumference of a tire. A plurality of first straps and a plurality of second straps are coupled to a first edge and a second edge of the panel, respectively. Each second strap and an associated first strap are configured to loopedly position around the tire and a rim of a vehicle. Each of a plurality of first couplers and each of a plurality of second couplers are coupled to a respective first strap and a respective second strap, respectively, distal from the panel. Each second coupler is positioned to couple to an associated first coupler to couple the panel to the tire, positioning the spikes to insert into a substrate to increase traction of the tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a traction enhancing device according to an embodiment of the disclosure.

FIG. 2 is a side view of an embodiment of the disclosure.

FIG. 3 is a front view of an embodiment of the disclosure.

FIG. 4 is a bottom view of an embodiment of the disclosure.

FIG. 5 is an in-use view of an embodiment of the disclosure.

FIG. 6 is an isometric perspective view of an embodiment of the disclosure.

### DETAILED DESCRIPTION OF THE INVENTION

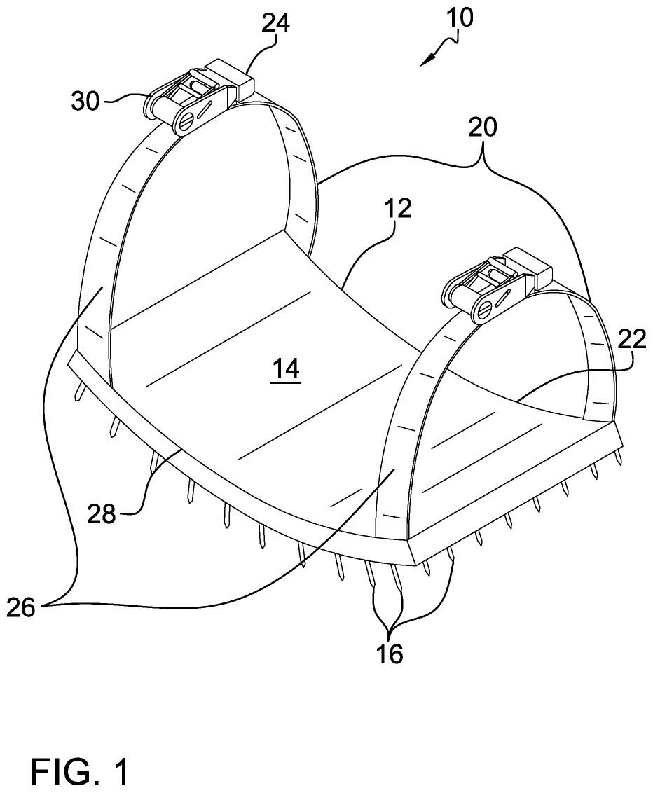

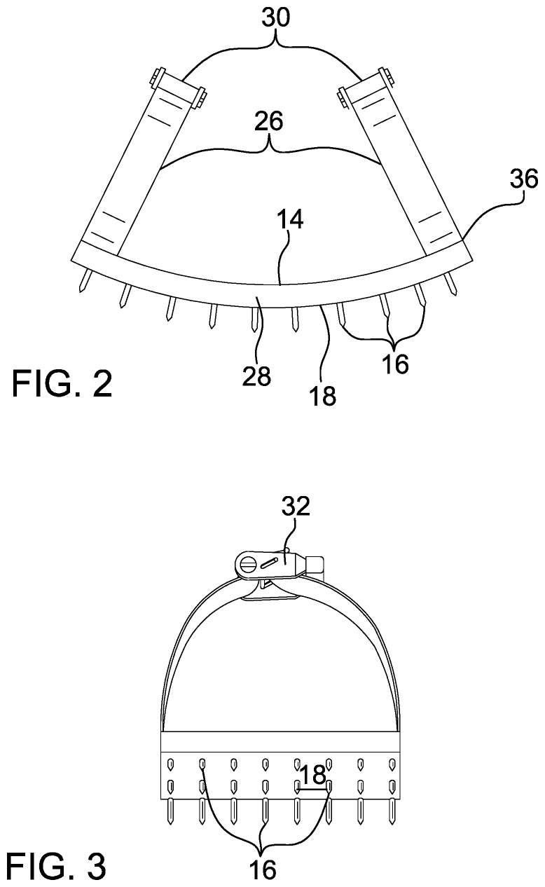

With reference now to the drawings, and in particular to FIGS. 1 through 6 thereof, a new traction enhancing device embodying the principles and concepts of an embodiment of the disclosure and generally designated by the reference numeral 10 will be described.

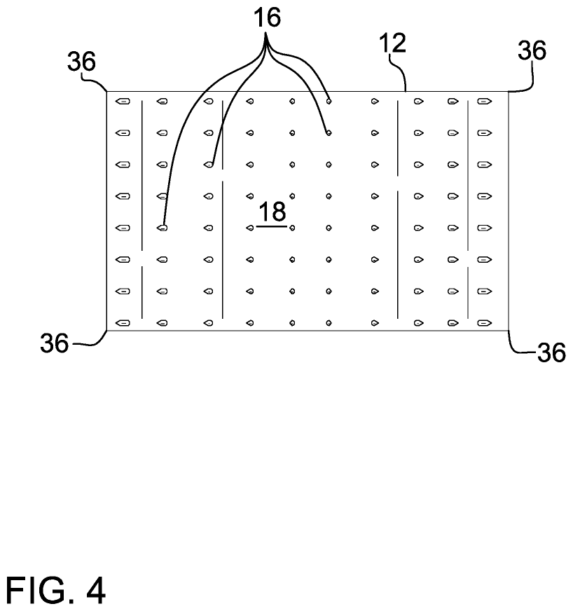

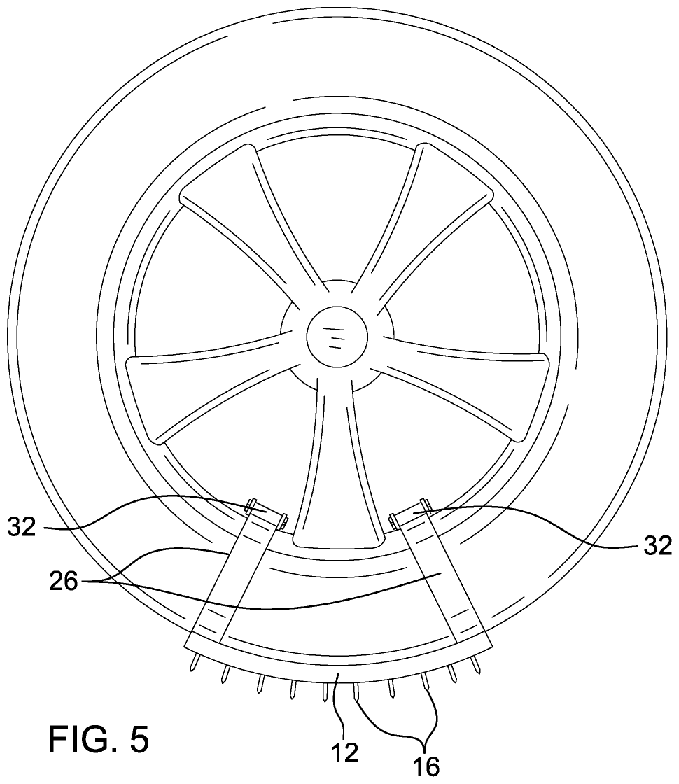

As best illustrated in FIGS. 1 through 6, the traction enhancing device 10 generally comprises a panel 12 that is substantially rectangularly shaped. The panel 12 is resiliently bendable so that an inner face 14 of the panel 12 is configured to conform to a circumference of a tire that is coupled to a respective rim of a vehicle. A plurality of spikes 16 is coupled to and extends from an outer face 18 of the panel 12, as shown in FIG. 4. The panel 12 comprises elastomer. The panel 12 comprises at least one of unsaturated rubber, saturated rubber, and silicone. The spikes 16 comprise at least one of metal, thermosetting plastic, or the like.

Each of a plurality of first straps 20 is coupled to extends from a first edge 22 of the panel 12. Each of a plurality of first couplers 24 is coupled to a respective first strap 20 distal from the panel 12.

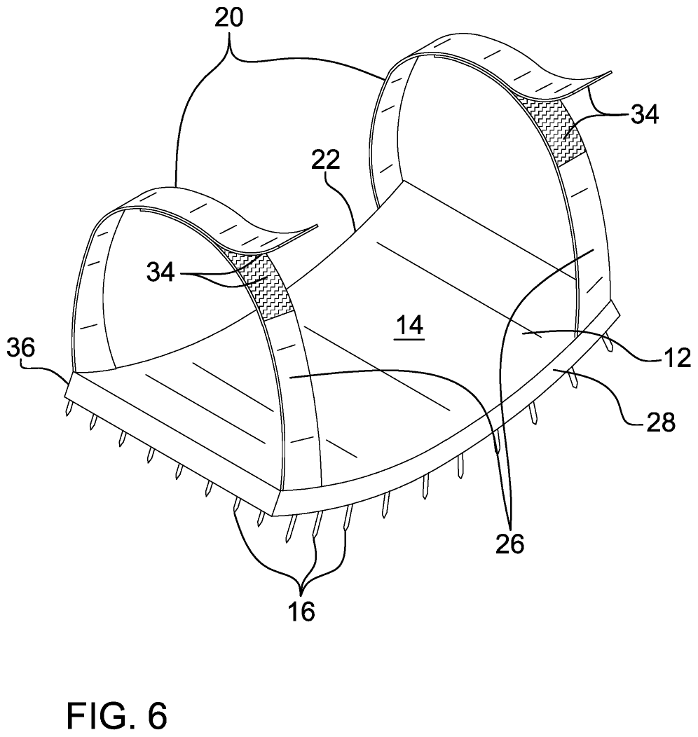

Each of a plurality of second straps 26 is coupled to and extends from a second edge 28 of the panel 12. The second strap 26 and an associated first strap 20 are configured to loopedly position around the respective rim, as shown in FIG. 5. The first straps 20 and the second straps 26 comprise nylon or the like. The plurality of second straps 26 comprises two second straps 26 that are positioned singly proximate to respective corners 36 of the panel 12, as shown in FIG. 1 and FIG. 6.

Each of a plurality of second couplers 30 is coupled to a respective second strap 26 distal from the panel 12. The second couplers 30 are complementary to the first couplers 24. Each second coupler 30 is positioned to selectively couple to an associated first coupler 24 to removably couple the panel 12 to the tire. The spikes 16 are configured to insert into a substrate, such as snow, mud, and sand, to increase traction of the tire in an emergency situation. The second coupler 30 and the associated first couplers 24 comprises at least one of a ratchet fastener 32, as shown in FIG. 1, and a hook and loop fastener 34, as shown in FIG. 6.

The device 10 is more easily attachable in the emergency situation relative to chains, which are typically used to enhance traction in snow, mud, and sand. Due to the ease of attachment to the rim, the device 10 is particularly suited for use by the elderly and physically disabled in the emergency situation.

In use, the inner face 14 of the panel 12 is positioned on the circumference of the tire so that the spikes 16 extend radially from the tire, as shown in FIG. 5. Each second strap 26 and the associated first strap 20 are loopedly positioned around tire and the respective rim. Each second coupler 30 then is positioned to couple to the associated first couplers 24 to removably couple the panel 12 to the tire so that the spikes 16 are configured to insert into the substrate as the tire rotates to increase the traction of the tire.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A traction enhancing device comprising:
a panel, the panel being resiliently bendable such that an inner face of the panel is configured for conforming to a circumference of a tire coupled to a respective rim of a vehicle;
a plurality of spikes coupled to and extending from an outer face of the panel;
a plurality of first straps, each first strap being coupled to extending from a first edge of the panel;
a plurality of first couplers, each first coupler being coupled to a respective first strap distal from the panel;
a plurality of second straps, each second strap being coupled to and extending from a second edge of the panel wherein the second strap and an associated first strap are configured for loopedly positioning around the respective rim; and
a plurality of second couplers, each second coupler being coupled to a respective second strap distal from the panel, the second couplers being complementary to the first couplers wherein each second coupler is positioned for selectively coupling to an associated first coupler for removably coupling the panel to the tire positioning the spikes for inserting into a substrate for increasing traction of the tire in an emergency situation.

2. The device of claim 1, further including the panel being substantially rectangularly shaped.

3. The device of claim 1, further including the panel comprising elastomer.

4. The device of claim 3, further including the panel comprising unsaturated rubber.

5. The device of claim 3, further including the panel comprising saturated rubber.

6. The device of claim 3, further including the panel comprising silicone.

7. The device of claim 1, further including the spikes comprising metal.

8. The device of claim 1, further including the spikes comprising thermosetting plastic.

9. The device of claim 1, further including the first straps and the second straps comprising nylon.

10. The device of claim 1, further including the plurality of second straps comprising two second straps positioned singly proximate to respective corners of the panel.

11. The device of claim 1, further including the second coupler and the associated first coupler comprising a ratchet fastener.

12. The device of claim 1, further including the second coupler and the associated first coupler comprising a hook and loop fastener.

13. A traction enhancing device comprising:
a panel, the panel being resiliently bendable such that an inner face of the panel is configured for conforming to a circumference of a tire coupled to a respective rim of a vehicle, the panel being substantially rectangularly shaped, the panel comprising elastomer, the panel comprising at least one of unsaturated rubber, saturated rubber, and silicone;
a plurality of spikes coupled to and extending from an outer face of the panel, the spikes comprising at least one of metal and thermosetting plastic;
a plurality of first straps, each first strap being coupled to extending from a first edge of the panel, the first straps comprising nylon;
a plurality of first couplers, each first coupler being coupled to a respective first strap distal from the panel;
a plurality of second straps, each second strap being coupled to and extending from a second edge of the panel wherein the second strap and an associated first strap are configured for loopedly positioning around the respective rim, the second straps comprising nylon, the plurality of second straps comprising two second straps positioned singly proximate to respective corners of the panel; and
a plurality of second couplers, each second coupler being coupled to a respective second strap distal from the panel, the second couplers being complementary to the first couplers wherein each second coupler is positioned for selectively coupling to an associated first coupler for removably coupling the panel to the tire positioning the spikes for inserting into a substrate for increasing traction of the tire in an emergency situation, the second coupler and the associated first coupler comprising at least one of a ratchet fastener and a hook and loop fastener.
